(19) United States
(12) Patent Application Publication
(10) Pub. No.: US 2005/0169693 A1
(43) Pub. Date: Aug. 4, 2005

(54) Paint applicators

(76) Inventors: Craig S. Serio, New Berlin, WI (US); Brian S. Potempa, Oak Creek, WI (US); Michael M. Potempa, Oak Creek, WI (US); Joshua Nelson, Milwaukee, WI (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/769,933

(22) Filed: Feb. 2, 2004

(51) Int. Cl. B43M 11/02

(52) U.S. Cl. 401/219; 401/208

(57) ABSTRACT

The disclosure generally relates to paint applicators, and more particularly to paint applicators comprising a container having an opening, and a housing assembly removably attached to the container, the housing assembly comprising a paint application element and a push-pull valve, the paint application element being adjacent to the push-pull valve, and the push-pull valve being in fluid communication with a contents of the container.

### FIELD OF THE DISCLOSURE

The disclosure generally relates to paint applicators, and more particularly to paint applicators comprising a container and a housing assembly removably attached to the container.

### BACKGROUND OF THE DISCLOSURE

Paint applicators such as paint brushes, paint rollers, and paint pads are well known. Brushes allow for accurate paint application and are readily available in a wide array of sizes. Paint rollers are often used to apply paint to relatively large surfaces, e.g., walls and ceilings. Foam paint pads can be used to apply paint to surfaces having intricate textures. Moreover, such paint pads often have straight or angular edges enabling paint application along a straight trim line or to a corner.

During use, however, conventional paint applicators must frequently be loaded with paint from a non-integral, secondary source such as a paint can or a roller tray. Such paint loading can be messy due to dripping, splattering, and the like, and wasteful due to paint adhering to the sides of the paint can, roller tray, and paint applicator. Exposing paint in this fashion can result in paint contamination and such contaminated paint can result in inferior finishes. Additionally, the secondary source must be refilled with paint each time a user wants to perform a paint job, thereby wasting time and paint each time a paint job is undertaken.

Moreover, cleaning such conventional paint applicators and the associated loading source can be messy and time-consuming. For example, paint roller covers must be removed from the associated paint roller device by grasping the paint soaked paint roller cover and pulling it off of the paint roller assembly frame. Subsequently, the user's hands must be thoroughly cleaned.

### SUMMARY OF THE DISCLOSURE

Paint applicators in accordance with the disclosure generally comprise a container and a housing assembly for housing a paint application element removably attached to the container. Paint applicators in accordance with the disclosure generally allow users to remove the paint application elements quickly and without engaging the paint application element, and thereby facilitate cleaning (in general) and discarding of the associated paint application elements. Moreover, the paint applicators in accordance with the disclosure include a self-contained paint supply and thus do not require paint loading from a non-integral, secondary source.

According to one embodiment according to the disclosure, a paint applicator, comprises a container having an opening, and a housing assembly removably attached to the container, the housing assembly comprising a paint application element and a push-pull valve, the paint application element being adjacent to the push-pull valve, and the push-pull valve being in fluid communication with a contents of the container.

According to an additional embodiment according to the disclosure, a paint applicator comprises a container having an opening, and a housing assembly removably attached to the container, the housing assembly comprising a paint roller cover and a valve, the paint roller cover being adjacent to the valve, the valve being in fluid communication with a contents of the container, and the valve comprising a face having a contour that is complementary to an outer diameter of the paint roller cover.

According to another embodiment according to the disclosure, a method of applying paint to a surface comprises engaging a surface with a paint applicator comprising a container having an opening, and a housing assembly removably attached to the container, the housing assembly comprising a paint roller cover and a valve, the paint roller cover being adjacent to the valve, the valve being in fluid communication with a contents of the container, and the valve comprising a face having a contour that is complementary to an outer diameter of the paint roller cover, and traversing the surface with the paint roller cover.

### BRIEF DESCRIPTION OF THE DRAWINGS

Exemplary aspects and features of paint applicators in accordance with the disclosure are described and explained in greater detail below with the aid of the drawing figures in which:

FIG. 1 is a perspective view illustrating a paint applicator in accordance with the disclosure;

FIG. 2 is a exploded view of the paint applicator shown in FIG. 1;

FIG. 3 is a front perspective view illustrating a housing assembly in accordance with the disclosure; and,

FIG. 4 is a rear perspective view of the housing assembly shown in FIG. 3.

### DETAILED DESCRIPTION OF THE DISCLOSURE

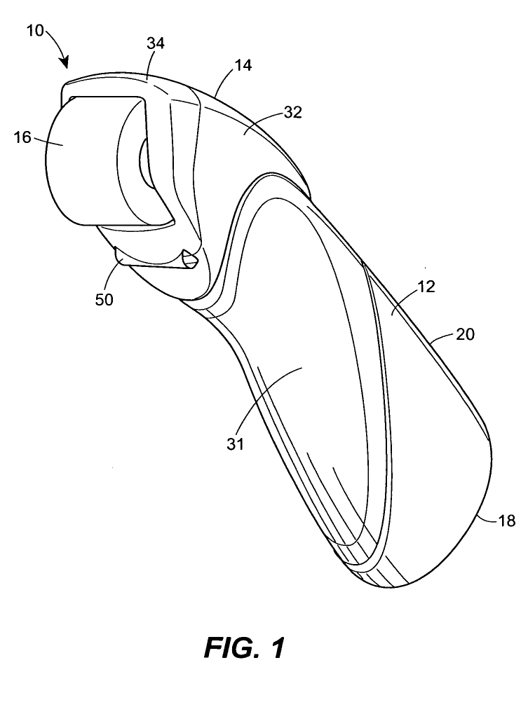

With reference to FIGS. 1-4, a paint applicator in accordance with the disclosure is generally shown as paint applicator 10. Paint applicators 10 generally include a container 12, a housing assembly 14, and a paint application element, exemplified in the Figures as a paint roller cover 16.

Container 12 includes a bottom surface 18 from which a perimeter side wall 20 upwardly extends. Container 12 can be of any suitable shape and/or configuration provided that container 12 is adapted to store a liquid such as paint and has an opening to receive housing assembly 14, as described below. While container 12 is described herein for use in conjunction with paint, it is understood that the term “paint” is defined as any type of material adapted to be applied to a surface for decoration or protection thereof. Accordingly, “paint” as used herein includes not only paint, but stains, lacquers, varnishes, sealants, adhesives, and the like.

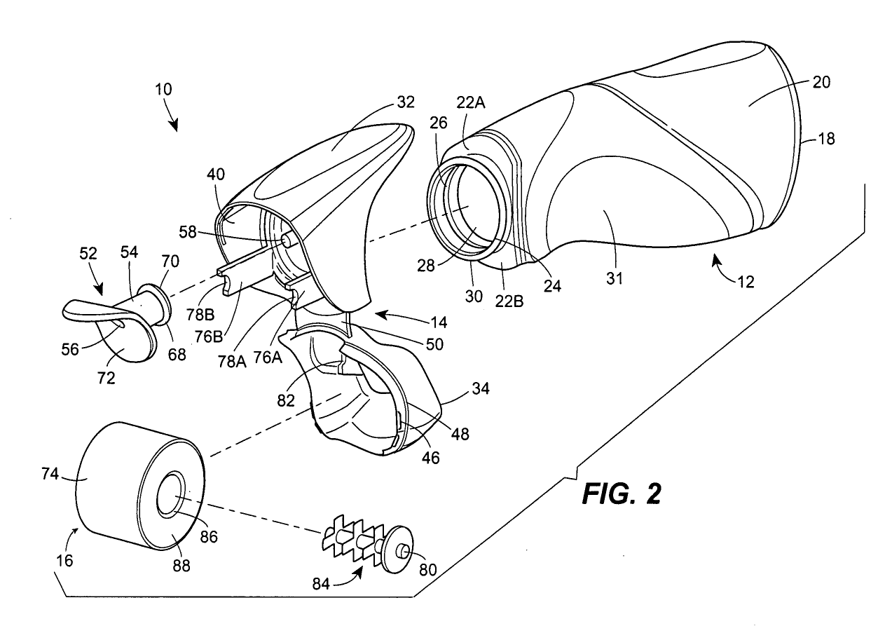

In the illustrated embodiment, side wall 20 of container 12 generally terminates at shoulders 22A, 22B, which provide a rim 24 extending therefrom (see FIG. 2). Rim 24 generally defines an opening 26 providing access to an interior 28 of container 12. Containers having openings 26 in different positions (i.e., not at the top of the container) may also be used. A bead 30 can be provided about the circumference of rim 24. Such a bead 30 can facilitate attachment of container 12 to housing assembly 14, as described below.

Container 12 can be configured such that a user can comfortably grasp container 12. For example, container 12 can be formed such that the dimensions of perimeter side wall 20 vary upwardly, e.g., at locations between bottom surface 18 and shoulders 22A, 22B, in order to provide an ergonomic gripping surface 31 for a user, as shown in FIGS. 1-4. At least a portion (not shown) of gripping surface 31 can be textured to further augment the user's ability to controllably apply paint to a surface to be painted with paint applicator 10.

Housing assembly 14 generally houses or contains paint application element when paint applicator 10 is in use. A number of paint application elements can be used in paint applicators 10 according to the disclosure. For example, although the paint application element is exemplified in the Figures as paint roller cover 16, a paint pad (not shown) or even bristled applicators (not shown) may alternatively be used. Additionally, the paint application may be of any size. For example, paint roller 16 cover may be about one inch long, about two inches long, about three inches long, etc., up to and including standard roller cover lengths.

Housing assembly 14 is removably attached to container 12 and thus can be removed to provide access to interior 28 of container 12. In one embodiment, housing assembly 14 substantially seals container 12, e.g., by a snap-fit interference engagement. Such a snap-fit interference engagement allows the user to quickly remove housing assembly 14 from container 12 and fill and/or empty the fluid contents of container 12.

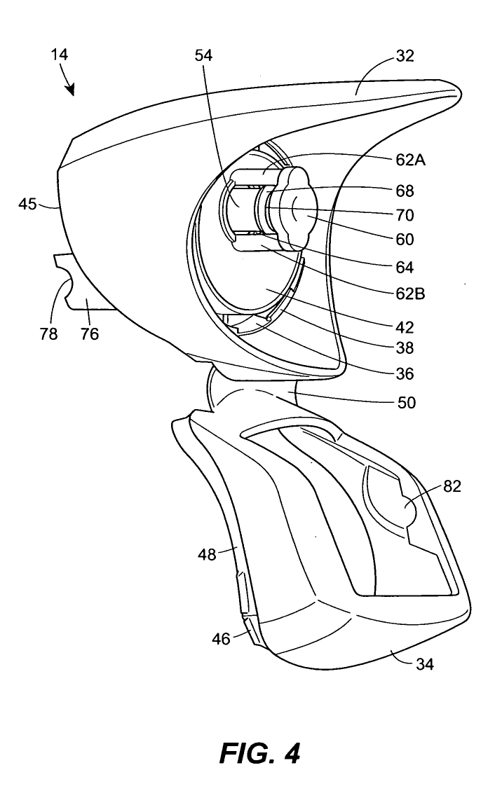

For example, in one embodiment housing assembly 14 comprises a cap 32 adapted to substantially seal opening 26 of container 12. Cap 32 can include an annular channel or groove 36 for releasably receiving rim 24 of container 12. As shown in FIG. 4, annular channel 36 can include a plurality of tabs or ribs 38 that are adapted to interact with bead 30 to provide a snap-fit interference engagement between cap 32 and container 12 and to substantially seal cap 32 to container 12.

Other mechanisms may also be used to attach cap 32 of housing assembly 14 to container 12. For example, threads (not shown) can be formed on the outside surface of container rim 24 and corresponding grooves (not shown) can be formed on the inside of housing assembly 14, as is conventionally known. Alternatively, the threads (not shown) can be formed on the inside of housing assembly 14 and corresponding grooves (not shown) can be formed on the outside of container rim 24.

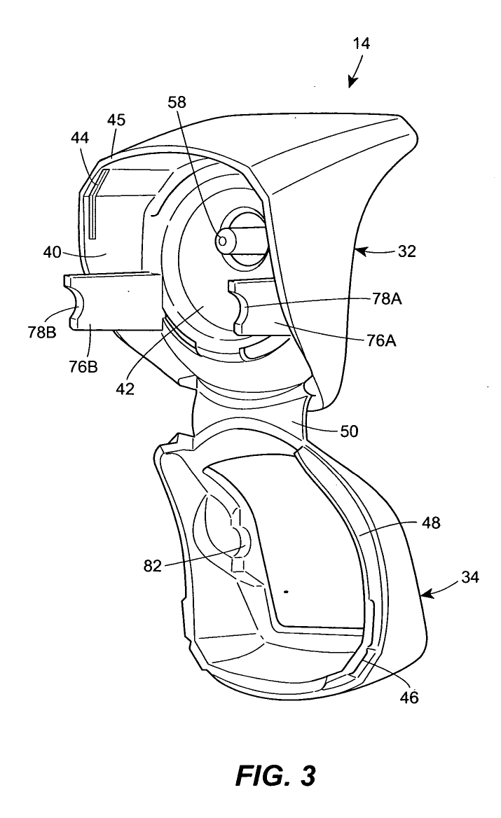

In another embodiment, housing assembly 14 comprises a cover 34 adapted to engage cap 32. Cap 32 generally includes a perimeter wall 40 extending from a sealing surface 42. In one aspect according to this embodiment, cap 32 includes a recessed area 44 disposed on a distal edge 45 of perimeter wall 40 and cover 34 includes a projection 46 disposed on a lower edge 48 of cover 34 as shown best in FIG. 3. Projection 46 of cover 34 is generally adapted to interact with recessed area 44 of cap 32 to provide a snap-fit interference engagement between cover 34 and cap 32. Such a snap-fit interference engagement allows the user to quickly disengage cover 34 from cap 32, thereby allowing the user to easily remove the paint application element for cleaning or discarding without touching the paint application element. Alternatively, recessed area 44 can be disposed on lower edge 48 of cap 32 and projection 46 can be disposed on distal edge 45 of perimeter wall 40. Cover 34 can also engage cap 32 via other mechanisms, including but not limited to other interference fits between cover 34 and cap 32, as is conventionally known.

As shown by FIGS. 2-4, a living hinge 50 comprising a continuous web of plastic between cover 34 and cap 32 can be used to fixedly connect cover 34 to cap 32. Living hinge 50 is advantageous for a number of reasons. For example, the user need not store cover 34 after disengaging cover 34 from cap 32 when living hinge 50 is used. Additionally, as depicted best in FIG. 3, living hinge 50 generally has an “hour glass” shape wherein the living hinge 50 exterior edge sections have a greater width than an interior section. Such a configuration for living hinge 50 provides a certain amount of resistance preventing cover 34 from opening past a certain point. In alternative embodiments, other forms of hinges can be employed. For example, a conventional two leaf hinge and pin design can be used to fixedly connect cover 34 to cap 32. Moreover, cap 32 can be fully separate from cover 34 and be provided with an alternative means of attachment, such as threads or a snap-fit interference engagement (as previously described). Additionally, an aperture (not shown) can be provided in the cap 32 or the cover 34 and a corresponding tab member (not shown) capable of interacting with the aperture can be provided on the cover 34 or the cap 32, respectively, to connect the cap 32 and the cover 34.

Cap 32 also generally includes a valve assembly 52. Valve assembly 52 is in fluid communication with fluid contents (not shown) contained within the interior 28 of container 12. In one embodiment according to the disclosure, valve assembly 52 is a push-pull valve that can be actuated between an open position permitting fluid dispensation from container 12 and a closed position precluding fluid dispensation from container 12 by pulling and pushing valve assembly 32 from and towards sealing surface 42, respectively. Such valves have been previously used in various containers, including water bottles. One suitable push-pull valve assembly is disclosed in U.S. Pat. No. 4,345,704. Of course, other conventional fluid regulating valves may be used including but not limited to, spool valves, sliding stem valves, rotary valves, and the like.

In the illustrated embodiment, valve assembly 52 includes a stem portion 54 having an aperture 56 that receives a post 58 which extends upwardly above sealing surface 42. Post 58 extends from a bridge 60 connected to sealing surface 42 by two members 62A, 62B. Aperture 56 and post 58 define a pathway 64 for valve 52 actuation and thus fluid flow. In one embodiment, aperture 56 of valve assembly 52 is provided above a central axis (not shown) of paint roller cover 16 in order to facilitate paint application through aperture 56 without mess.

When valve assembly 52 is actuated to an open position permitting fluid flow from the container 12, an annular flange 68 disposed at a terminal end 70 of stem portion 54 prevents the detachment of valve assembly 52 from cap 32. When valve assembly is in the closed position, annular flange 68 prevents fluid from flowing from container 12 to the associated paint application element. FIG. 4 shows valve assembly 52 in the closed position, i.e., annular flange 68 is in contact with bridge 60.

In one embodiment, valve assembly 52 includes a face 72 having a contour that is complementary to an outer diameter 74 of paint roller cover 16. Contoured face 72 may contact outer diameter 74 of paint roller cover 16 when valve assembly 52 is actuated to an open position. Providing a valve assembly with contoured face 72 enables controlled fluid dispensation from container 12 to paint roller cover 16. For example, when the user squeezes container 12 to force paint through the valve assembly 52 to paint roller cover 16, messy paint loading of paint roller cover 16 is eliminated. Additionally, when contoured face 72 is in contact with outer diameter 74 of paint roller cover 16, paint roller cover 16 can wipe paint from contoured face as paint roller cover 16 traverses (i.e., is rolled) across a surface to be painted, thereby preventing additional mess.

In one embodiment, cap 32 is adapted to engage the paint application element, e.g., paint roller cover 16. For example, in the illustrated embodiment, posts 76A, 76B extend from sealing surface 42 above perimeter wall 40 of cap 32. Posts 76A, 76B include cup-shaped receptacles 78A, 78B for receiving an axle 80 of paint roller cover 16. Receptacles having other shapes may also be used to retain the paint application element.

Cover 34 can also be similarly adapted to engage the paint application element. For example, cover 34 can include cup-shaped receptacles 82A, 82B for receiving axle 80 of paint roller cover 16. When cover 34 engages cap 32, cup-shaped receptacles 78A, 78B and 82A, 82B form an aperture (not shown) for releasably receiving axle 80 of paint roller cover 16.

In an exemplary embodiment, axle 80 comprises a removable cage 84 adapted to frictionally engage an inside surface of roller cover 16. Alternatively, axle 80 can be integrally formed with paint roller cover 16. Paint roller cover 16 generally comprises a core 86 having an outer circumferential surface configured to be rolled along a surface and to apply (or remove) paint from the adjacent surface. Core 86 is sized so as to be fitted about axle 80. Core 86 is typically formed from a thermoplastic material, but other conventional materials suitable for core manufacture can also be used.

Paint roller covers 16 may include a pile fabric 88 secured to core 86. The pile fabric 88 holds and retains paint until the paint is applied to a surface such as a wall. Core 86 can be covered by various materials including but not limited to flocked foam, fabric nap, mohair, natural or synthetic sponge, felt, and the like for the adsorption and application of paint, as is conventionally known.

The disclosure also provides methods of using paint applicators 10. In the disclosed methods, a user engages a surface to be painted with a paint applicator comprising a container having an opening, and a housing assembly removably attached to the container, the housing assembly comprising a paint roller cover and a valve, the paint roller cover being adjacent to the valve, and the valve being in fluid communication with a contents of the container, and traversing the surface with the paint roller cover. The methods may further include opening the valve to facilitate paint application. The methods may also include positioning the valve in contact with an outer diameter of the paint roller cover. Additionally, the valve can be closed to store the paint contained in container for an extended period of time, without clean-up of the paint applicator. Accordingly, the paint applicators in accordance with the disclosure do not necessitate continuous reloading of a secondary source each time a paint job is initiated.

Containers, caps, and covers for paint applicators according to the disclosure can be manufactured through a variety of methods including, without limitation, injection molding, injection stretch blow molding, thermoforming, extrusion blow molding, injection blow molding, insert molding, co-injection molding, rotational molding, and other methods known in the art. Injection blow molding is the preferred method for manufacturing of containers in accordance with the disclosure. Injection molding is the preferred method for manufacturing caps and covers in accordance with the disclosure.

The containers in accordance with the disclosure are generally flexible enough to allow a user to squeeze the fluid contents contained therein and thereby dispense the fluid contents. A variety of thermoplastic resins can be used to manufacture containers and caps in accordance with the disclosure, including polyethylenes (e.g., high density polyethylene or linear low density polyethylene), polypropylenes (including structural foam comprising polypropylene), polyethylene terephthalates, polyvinyl chlorides, polycarbonates, etc. High density polyethylene and polyethylene terephthalate are preferred materials for cap and container construction, respectively.

Additionally, various thermoplastic elastomers, such as Santoprene® products (Advanced Elastomer Systems, L.P., Akron, Ohio), can be used to provide rubbery gripping surfaces on the exterior of containers in accordance with the disclosure.

Although the foregoing text sets forth a detailed description of numerous different embodiments of paint applicators comprising a container and a housing assembly removably attached to the container, it should be understood that the detailed description is to be construed as exemplary only and does not describe every possible embodiment of such paint applicators.

1. A paint applicator, comprising:
a container having an opening; and,
a housing assembly removably attached to the container, the housing assembly comprising a paint application element and a push-pull valve, the paint application element being adjacent to the valve, and the push-pull valve being in fluid communication with a contents of the container.

2. The paint applicator according to claim 1, wherein the housing assembly comprises a cap adapted to substantially seal the opening of the container, and a cover adapted to engage the cap.

3. The paint applicator according to claim 2, further comprising a living hinge connecting the cover to the cap.

4. The paint applicator according to claim 2, wherein the rim comprises a bead and the cap includes an annular channel for receiving the rim, the annular channel including a plurality of ribs adapted to interact with the bead to substantially seal the cap to the container.

5. The paint applicator according to claim 2, wherein the cap includes a recess and the cover includes a projection adapted to interact with the recess to provide a snap-fit engagement between the cap and the cover.

6. The paint applicator according to claim 2, wherein the cover includes a recess and the cap includes a projection adapted to interact with the recess to provide a snap-fit engagement between the cap and the cover.

7. The paint applicator according to claim 2, wherein the cap is adapted to engage the paint application element.

8. The paint applicator according to claim 7, wherein the cover is adapted to engage the paint application element.

9. The paint applicator according to claim 1, wherein the paint application element is a paint pad.

10. The paint applicator according to claim 1, wherein the paint application element is a paint roller cover.

11. The paint applicator according to claim 10, wherein the push-pull valve comprises a face having a contour that is complementary to an outer diameter of the paint roller cover.

12. The paint applicator according to claim 11, wherein the face is in contact with an outer diameter of the paint roller cover.

13. The paint applicator according to claim 1, wherein an aperture of the push-pull valve is positioned above a centerline of the paint application element.

14. A paint applicator, comprising:
a container having an opening; and,
a housing assembly removably attached to the container, the housing assembly comprising a paint roller cover and a valve, the paint roller cover being adjacent to the valve, the valve being in fluid communication with a contents of the container, and the valve comprising a face having a contour that is complementary to an outer diameter of the paint roller cover.

15. The paint applicator according to claim 14, wherein the housing assembly comprises a cap adapted to substantially seal the opening of the container, and a cover adapted to engage the cap.

16. The paint applicator according to claim 15, further comprising a living hinge connecting the cover to the cap.

17. The paint applicator according to claim 15, wherein the rim comprises a bead and the cap includes an annular channel for receiving the rim, the annular channel including a plurality of ribs adapted to interact with the bead to substantially seal the cap to the container.

18. The paint applicator according to claim 15, wherein the cap includes a recess and the cover includes a projection adapted to interact with the recess to provide a snap-fit engagement between the cap and the cover.

19. The paint applicator according to claim 15, wherein the cover includes a recess and the cap includes a projection adapted to interact with the recess to provide a snap-fit engagement between the cap and the cover.

20. The paint applicator according to claim 15, wherein the cap is adapted to engage the paint roller cover.

21. The paint applicator according to claim 20, wherein the cover is adapted to engage the paint roller cover.

22. The paint applicator according to claim 14, wherein the valve is in contact with an outer diameter of the paint roller cover.

23. The paint applicator according to claim 14, wherein the valve is a push-pull valve.

24. The paint applicator according to claim 14, wherein an aperture of the valve is positioned above a center line of the paint roller cover.

25. A method of applying paint to a surface, comprising:
engaging a surface with a paint applicator comprising a container having an opening, and a housing assembly removably attached to the container, the housing assembly comprising a paint roller cover and a valve, the paint roller cover being adjacent to the valve, the valve being in fluid communication with a contents of the container, and the valve comprising a face having a contour that is complementary to an outer diameter of the paint roller cover; and,
traversing the surface with the paint roller cover.

26. The method according to claim 25, further comprising opening the valve.

27. The method according to claim 25, further comprising positioning the valve in contact with an outer diameter of the paint roller cover.

28. The paint applicator according to claim 25, further comprising closing the valve to store the contents.
